(19) United States
(12) Patent Application Publication
(10) Pub. No.: US 2010/0322823 A1
(43) Pub. Date: Dec. 23, 2010

(54) Rapid Detection of Post-Vaccination Antibody Response

(76) Inventors: Krishna P. Surapaneni, Anaheim Hills, CA (US); Prasadarao Gandlur, Hyderabad (IN); Vednla Venkata Suryanarayana, Secunderabad (IN); Ajai Kumar Pathak, Hyderabad (IN)

Correspondence Address: Novel IP, 14252 CULVER DR. BOX 914, IRVINE, CA, 92604, US

(21) Appl. No.: 12/478,600

(22) Filed: Jun. 4, 2009

Related U.S. Application Data
(60) Provisional application No. 61/058,866, filed on Jun. 4, 2008.

(51) Int. Cl. G01N 30/00

(52) U.S. Cl. 422/69

(57) ABSTRACT

The present inventions are directed to apparatuses for rapidly measuring post-vaccination immune status. In one version, the apparatus has a support platform, with a top side, a bottom side, a first portion, and a second portion. A first void is integrally formed in the first portion. A container is configured to be removably affixed to the top side of the support platform. The container has a housing, a base, and at least one reactant. The container base can be viewed through the first void when the container is removably affixed to the first portion of the top side. An absorbent material is affixed to the second portion, where the base of the container comes into contact with the absorbent material when the container is removably affixed to the second portion of the top side.

### CROSS-REFERENCE

The present application relies on U.S. Patent Provisional Application No. 61/058,866, which was filed on Jun. 4, 2008.

### FIELD OF THE INVENTION

The present invention generally relates to apparatuses, methods, and compositions for detecting the presence of antibodies in body fluids, including blood, serum, plasma, tears, lactate, saliva, urine or feces. The present invention also relates generally to apparatuses, methods, and compositions for detecting the presence of antibodies in body fluids to determine the immune status of vaccinated individuals by using various detectable analytes, such as bacteria, protozoa, viral proteins, allergens, viral cell lysates, bacterial cell lysates, and carbohydrates as capture antigens. The present invention relates, more specifically, to apparatuses, methods, and compositions for detecting the presence of antibodies in human body fluids by using a sink-in (hereinafter referred to as “SINK-SORB”) technology.

### BACKGROUND OF THE INVENTION

A range of immuno-chromatographic devices have been developed and employed for detecting analytes present in body fluids such as serum, blood, plasma, saliva and urine. Conventionally, in vitro diagnostic tests are performed on the surface of a dry, porous sheet or a strip of nitrocellulose membrane, generally having a defined sample application site for depositing sample materials and a test detection site for viewing the assay result.

Conventional rapid-flow immuno-chromatographic test devices typically comprise various components, including, a plastic or paper housing which permit the viewing of a reaction area on a porous strip; a sample pad at one end of the housing allowing the addition of sample; a conjugate pad; a membrane that incorporates capture reagents, and an absorbent pad (of absorbent bibulous material) at the end the sample pad for absorbing a flowing sample, buffers and colloids.

Generally, a typical test device is operated by dispensing a patient sample (usually urine, serum, plasma or whole blood) onto a sample pad. The patient's sample then flows through the sample pad onto a conjugate pad, where it combines with and subsequently releases a detector reagent. The resultant patient sample and conjugate mixture then flows across a reagent membrane and binds to test and control reagents. As the mixture binds to the test reagent, a result is indicated. The color intensity of the test line is generally proportional to the concentration of analyte in the sample. The absorbent pad absorbs the excess sample that flows beyond the test and control reagent parameter lines.

Conventional chromatographic immunoassays are generally designed to detect analytes using the following two methods: a) the detection of proteins or small molecule anaytes found in human body fluids, such as hormones, cancer proteins, therapeutic drugs and viral/bacterial proteins and b) the detection of analytes like human antibodies specifically reactive with agents such as viral/bacterial proteins (HIV, Hepatitis A, Hepatitis C, Rubella, CMV, HSV, Dengue Fever, Lyme Disease, Chagas TB, autoimmune diseases, and the like) or allergens.

For example, U.S. Pat. No. 5,420,014 (“the '014 patent”), assigned to Auspharm International Ltd., describes “a method for detecting contempory infection by H. pylori in a mammal comprising contacting a mucous secretion from said mammal with an antigen component from H. pylori for a time and under conditions sufficient for an IgG antibody in said mucous secretion specific to said antigen component to form a complex therewith and then subjecting said complex to a detecting means.” The '014 patent further describes that the “detecting means contemplated by the present invention allows the identification of an antibody-antigen complex . . . facilitated by contacting the solid support with a second antibody, conjugated with a reporter molecule, and which is specific for at least part of the class of H. pylori-specific antibody found in the secretion, which, in accordance with the invention, is IgG.”

In another example, U.S. Pat. No. 5,846,751 (“the '751 patent”), assigned to Quidel Corporation, discloses “[a] sensitive and specific antigen preparation for the detection of Helicobacter pylori in biological samples . . . [t]he preparation uses a range of antigens derived from size exclusion chromatography of detergent-solubilized H. pylori cells.” Still further, the '751 patent describes that “ . . . the antigen complex is detected by a method selected from the group consisting of enzyme-linked immunosorbent assay, radioimmunoassay, complement fixation, indirect hemagglutination, latex agglutination, rapid flow-through assay and lateral flow assay.”

Additionally, U.S. Pat. No. 5,547,833, assigned to Intracel Corporation, describes “assay reageants, methods, and apparatus, and more particularly to radial flow assay apparatus and methods providing rapid and sensitive determination of an analyte in a variety of test assays.”

Additionally, U.S. Pat. No. 6,528,325, assigned to Dexall Biomedical Labs, Inc., describes “[a] lateral flow immunoassay device for detecting immune reactants, said device comprising: a test strip, said test strip comprising: a) a sample site for applying a sample comprising antibodies; b) a colorimetric labeling site for labeling the sample, forming a colorimetric antibody complex, said colorimetric labeling site comprising a colorimetric labeled anti-IgE antibody, said calorimetric labeling site positioned downstream from said sample site; c) a plurality of reaction sites downstream from said labeling site, each said reaction site containing a different allergen such that when IgE antibodies labeled with colorimetric labeled anti-IgE antibodies come in contact with an antigen to which the IgE antibodies react, the reaction site will develop a colored line, indicating a positive response; and wherein said allergens are immobilized to said test strip using at least one solubilizing agent, said at least one solubilizing agent being present in an amount such that said allergen protein tertiary structure unfolds to allow for greater binding of said antigen to said test strip, wherein said at least one solubilizing agent is selected from the group consisting of sugars and alcohols.”

Additionally, U.S. Patent Publication No. 20060019406, assigned to

Kimberly-Clark Worldwide Inc., describes “[a] lateral flow assay device for detecting the presence or quantity of an analyte residing in a test sample, said lateral flow assay device comprising a porous membrane, said porous membrane being in communication with a conjugate pad and a wicking pad, said porous membrane defining: a detection zone where said test sample is applied and within which is immobilized a first capture reagent, said first capture reagent being configured to bind to at least a portion of said analyte and analyte-conjugate complexes to generate a detection signal having an intensity; a control zone located downstream from said detection zone, wherein a second capture reagent is immobilized within said control zone, said second capture reagent being configured to bind to said conjugate or conjugate-analyte complexes; said conjugate pad located upstream from said detection zone, said conjugate zone having detection probes with specific binding members for the analyte and; said buffer release zone located upstream of said conjugate pad and providing for buffer addition to said device, said buffer serving to move said detection probes to said detection zone and to said control zone.”

U.S. Patent Publication No. 20040002063, assigned to MedMira, Inc., describes “[a] device for determining the presence or absence of anti-vaccinia virus antibodies in a fluid test sample, comprising: a test unit comprising a reaction zone in vertical communication with an absorbent zone, wherein the reaction zone contains a vaccinia viral lysate immobilized therein, said vaccinia viral lysate capable of specific binding with anti-vaccinia virus antibodies present in the fluid test sample to form an immune-complex; and a post-filter unit comprising a label zone containing a dried indicator reagent, wherein following resolubilization by a buffer reagent, said indicator reagent is capable of specifically binding to the immune-complex to produce a visually detectable signal; and wherein the reaction zone of the test unit and the label zone of the post-filter unit are capable of being disposed in transient fluid communication with each other so as to allow direct passage of resolubilized indicator reagent from the label zone into the reaction zone following application of the buffer reagent to the label zone.”

And finally, U.S. Pat. No. 6,927,068, assigned to the USA, represented by the Secretary of the Navy, describes “[a] method for detecting the presence of an antibody to Bacillus anthracis antigen, the antibody present in a sample selected from one or more bodily fluids which comprises the following steps: (a) contacting the sample with a conjugate label comprising a label conjugated to a binding partner for the antibody in the sample, thereby forming an antibody-conjugated label complex; and (b) allowing the antibody-conjugated label complex to migrate along a lateral-flow assay membrane and contact at least one membrane-bound recombinant Bacillus anthracis protective antigen, thereby forming an antigen-antibody complex and causing the indicator dye to precipitate and form a detectable signal, whereby the presence of the antibody is determined in the sample by an intensity or presence of the signal.”

Vaccines are routinely administered to children and adults for protection from high-risk infectious diseases, such as, but not limited to Polio (3 types), Diphtheria, Tetanus, Pertussis, Tuberculosis, Mumps, Measles, Rubella, H. pylori and Hepatitis. The administered vaccines are, however, rarely monitored for efficacy. One exception is a study published by Wattigney W. A. et. al. in PEDIATRICS Vol. 107 No. 5, 2001, that discusses monitoring of the oral polio vaccine. Such studies employ ELISA or Neutralization tests, however, are time consuming and only cover a few vaccine subjects.

Diagnostic devices must be designed such that they can be produced inexpensively, as these devices are generally disposable after a single use. Accordingly, there is a significantly high demand and need for test devices that are capable of providing rapid and reproducible results.

What is needed is a simpler, faster and more sensitive approach for the detection of antibodies reactive to the viral/bacterial proteins or allergens.

What is also needed is a rapid response post-vaccination antibody detection kit that is inexpensive and easy to use.

Thus, what is needed is a test device kit that has maximum sensitivity and specificity but requires a minimal sample volume.

Further, there is a need for the rapid and simultaneous detection of immune response against vaccination with multiple vaccines by detecting specific antibodies utilizing a novel SINK-SORB technology to monitor post vaccination immune status of children or other individuals.

### SUMMARY OF THE INVENTION

The present invention is directed toward an apparatus for rapidly measuring post-vaccination immune status, comprising a support platform, having a top side, a bottom side, a first portion, a second portion, wherein a first void is integrally formed in said first portion; a container configured to be removably affixed to the top side of the support platform, wherein said container comprises a housing, a base, and at least one reactant and wherein the base of said container can be viewed through said first void when said container is removably affixed to the first portion of the top side; and an absorbent material affixed to said second portion, wherein the base of said container comes into contact with said absorbent material when said container is removably affixed to the second portion of the top side.

Optionally, the support platform comprises a plurality of grooves. The container comprises a collar configured to be slidably inserted into, and out of, said grooves. The container comprises a sample pad layer, at least one layer for providing support to the sample pad layer, a conjugate pad, and a reaction membrane. The container further comprises a polymer membrane. The absorbent material comprises a buffer. The first void is covered with a transparent polymer film. The sample pad layer is formed from a material that increases a concentration of a sample applied to said sample pad layer. The conjugate pad comprises gold particles, which when placed into contact with a sample containing at least one antibody, form a complex with said antibody. The reaction membrane comprises a porous membrane having at least one capture antigen. The porous membrane is of a size ranging from 0.05 to 20 microns. The reaction membrane comprises a plurality of capture antigens radially positioned on the reaction membrane to allow for simultaneous analysis of multiple vaccine-derived immune responses. The specific antigen is immobilized on the reaction membrane for detection of polio vaccine antibody. The polymer membrane comprises at least one of a hydrophilic polymer, a synthetic polymer, colloidon, disaccharide, natural polymer, hydrophobic polymer, PVP, PVC, or polythene.

In another embodiment, the present invention is directed toward an apparatus for rapidly measuring post-vaccination immune status, comprising: a support platform, having a top side, a bottom side, a first portion, a second portion, wherein a first void is integrally formed in said first portion and covered by a membrane; a container configured to be removably affixed to the top side of the support platform, wherein said container comprises a housing, a base, and at least one reactant and wherein the base of said container is placed into contact with said membrane when said container is removably affixed to the first portion of the top side and wherein the base of said container is placed into contact with a material different from said support platform when said container is removably affixed to the second portion of the top side.

Optionally, the container comprises a sample pad layer, at least one layer for providing support to the sample pad layer, and a conjugate pad. The container further comprises a polymer membrane and a wipe pad. The material different from said support platform is an absorbent material that comprises a composition for washing away excess regents. The conjugate pad comprises gold particles, which when placed into contact with a sample containing at least one antibody, form a complex with said antibody. The membrane comprises nitrocellulose.

### BRIEF DESCRIPTION OF THE DRAWINGS

These and other features and advantages of the present invention will be appreciated, as they become better understood by reference to the following detailed description when considered in connection with the accompanying drawings wherein:

FIG. 1a illustrates a first perspective view of an embodiment of a fully assembled, self-contained rapid detection kit of the present invention, in which a reaction membrane is part of a removable pillbox assembly;

FIG. 1b illustrates a second perspective view of an embodiment of a fully assembled, self-contained rapid detection kit of the present invention, in which a reaction membrane is part of a removable pillbox assembly;

FIG. 1c illustrates a third perspective view of an embodiment of a fully assembled, self-contained rapid detection kit of the present invention, in which a reaction membrane is part of a removable pillbox assembly;

FIG. 2 is an illustration of a first embodiment of a self-contained rapid detection kit of the present invention, with the pillbox assembly removed from the support platform;

FIG. 3 is an expanded view of the various layers in one embodiment of a pillbox container assembly used in the rapid detection kit of the present invention, shown in FIG. 1;

FIG. 4a is an expanded, bottom perspective view of the various layers in one embodiment of a pillbox container assembly used in the rapid detection kit of the present invention, shown in FIG. 1;

FIG. 4b is an expanded view of the various layers in one embodiment of a pillbox container assembly used in the rapid detection kit of the present invention, shown in FIG. 1, further showing a test membrane having at least one antigen;

FIG. 5 is a top view illustration of one embodiment of an exemplary rapid test detection kit of the present invention, shown in FIG. 1;

FIG. 6 is a bottom view illustration of one embodiment of an exemplary rapid test detection kit of the present invention as shown in FIG. 1, further showing test results;

FIG. 7 is a side perspective view of a second embodiment of a self-contained rapid detection kit of the present invention, in which the test membrane is part of a support platform, with the pillbox assembly removed from the support platform;

FIG. 8a is an expanded view of the various layers in one embodiment of a pillbox container assembly used in the rapid detection kit of the present invention, shown in FIG. 7;

FIG. 8b is another expanded view of the various layers in one embodiment of a pillbox container assembly used in the rapid detection kit of the present invention, shown in FIG. 7;

FIG. 9a is a first illustration of an exemplary rapid detection test kit as shown in FIG. 7, for testing this efficacy of an administered polio vaccine, while in use;

FIG. 9b is a second illustration of an exemplary rapid detection test kit as shown in FIG. 7, for testing this efficacy of an administered polio vaccine, while in use;

FIG. 9c is a third illustration of an exemplary rapid detection test kit as shown in FIG. 7, for testing this efficacy of an administered polio vaccine, while in use;

FIG. 9d is a fourth illustration of an exemplary rapid detection test kit as shown in FIG. 7, for testing this efficacy of an administered polio vaccine, while in use; and

FIG. 9e is a fifth illustration of an exemplary rapid detection test kit as shown in FIG. 7, for testing this efficacy of an administered polio vaccine, while in use.

### DETAILED DESCRIPTION OF THE INVENTION

In one embodiment, the present invention is directed towards a rapid detection test kit and method for the detection of antibody (in response to a respective vaccination) in human body fluids such as, but not limited to, serum, plasma, blood, milk, urine or feces using a capture antigen, such as, but not limited to viral or bacterial cell lysates or their derivatives.

Thus, the present invention is directed toward a device and method that can be used for the detection of the presence of protective antibodies produced in the body in response to respective vaccinations. Protective antibodies may be produced in response to vaccination against diseases such as, but not limited to, polio, tuberculosis, diphtheria, hepatitis, mumps, pertussis, tetanus, influenza, meningitis, encephalitis and measles.

Accordingly, the present invention is directed towards a device and method for the detection of specific antibodies reactive to analytes such as, but not limited to, bacterial and viral proteins in a serum, plasma or blood and other biological fluids.

In particular, the present invention is directed towards a method and apparatus for the rapid detection of immune response to vaccination with at least one vaccine by detecting specific antibodies, utilizing SINK-SORB technology, to monitor post-vaccination immune status of children or other individuals.

In one embodiment, the present invention is directed towards a rapid detection kit that employs SINK-SORB technology. The SINK-SORB technology of the present invention has several advantages over the prior art conventional lateral flow method, including but not limited to a shorter traversing distance for the sample (the antibodies are deposited directly above the antigen spots, increasing reaction sensitivity); better placement of multiple antigens (using conventional lateral flow, the antigens are placed in series increasing test sensitivity only for those closely located antigens; the present invention places the antigens radially, at equal distances); a nonporous transparent laminate may be used on the viewing side to eliminate the effects of ambient moisture and air because the SINK-SORB technology relies on gravitational flow versus capillary flow; and wash sponges can be incorporated in the test kit. It should be noted that it is not desirable to use a non-porous transparent laminate on the viewing side of the diagnostic kit when employing a conventional lateral flow method because the non-porosity of the material would hinder the flow of the sample.

The present invention is also directed towards a method and apparatus for the rapid and simultaneous detection of immune response to vaccination with a plurality of vaccines by detecting specific antibodies, utilizing SINK-SORB technology, to monitor post-vaccination immune status of children or other individuals. In one embodiment, the rapid detection kit of the present invention features antigens placed in a radial design which facilitates the simultaneous and rapid detection of several antibodies specific to respective analytes.

In one embodiment, the present invention is directed towards a rapid detection kit that employs a novel flow-through or SINK-SORB method to screen for the presence of specific antibodies reactive with analytes such as bacteria, viral proteins and allergens in immunized individuals. In one embodiment, the rapid detection kit of the present invention is capable of screening for a plurality of antibodies simultaneously.

In another embodiment, the present invention is directed towards a rapid detection kit that employs a lateral flow technique to simultaneously screen for the presence of a plurality of specific antibodies reactive with analytes such as bacteria, viral proteins and allergens in immunized individuals. Thus, in a second embodiment, the present invention employs an improved lateral flow method by arranging several lateral flow membranes radially with a single central sample application pad.

The method and device of the present invention, in one embodiment, detects IgG antibodies in the serum and IgA in fecal matter and saliva (or other human body fluids). In one embodiment, antigens are immobilized on a test membrane strip, such as nitrocellulose. The antibodies present in body fluids form a complex with colloidal gold/colored latex particles. Once the complex is formed, it moves across a series of membranes, and produces a colored line of antigen-antibody complex to indicate the presence of specific antibodies for a particular antigen.

In one embodiment, the present invention can be used for both qualitative and quantitative analysis of immune response (IgG and IgA levels) in children and adult individuals that have been vaccinated against diseases such as, but not limited to, Polio (3 types), Diphtheria, Tetanus, Pertussis, Tuberculosis, Mumps, Measles, Rubella, H. pylori, Encephalitis, Meningitis and Hepatitis.

In one embodiment, the present invention is directed towards a rapid detection test kit that employs a novel flow-through or SINK-SORB technology and method to screen for the presence of an antibody response after vaccination with a polio vaccine. In one embodiment, the present invention is directed towards a simple, inexpensive, and stable rapid detection kit that can be used in field conditions. Thus, the present invention is directed towards a rapid detection kit that provides health professionals with a rapid diagnostic test method for monitoring the immune status of individuals post-vaccination.

The rapid detection kit of the present invention is, in one embodiment, designed for use as a diagnostic test for determining the efficacy of vaccination. In another embodiment, the rapid detection kit of the present invention may be used for screening individuals earlier vaccinated to determine whether there is a need for re-vaccination or to determine the number of booster doses needed.

Thus, the present invention is directed towards providing a rapid detection kit and method for using the kit that will enable the user to determine the efficacy of an individual vaccination or will determine the presence or absence of protective antibodies in various human body fluid samples of an individual who was earlier vaccinated.

In one embodiment, the present invention is directed towards a rapid detection test kit employing a conjugate pad comprising biotinylated anti-human IgG or IgA antibodies complexed with streptavidin conjugated gold or colored latex nano-particles and a nitrocellulose strip comprising an antigen or group of antigens extracted from a vaccine, immobilized or deposited thereon. If the individual has specific antibodies to the antigen of interest upon addition of a test sample, a colored line is produced on the nitrocellulose strip.

In a first embodiment, the nitrocellulose membrane is contained within and integral to a removable pillbox container, having various layers, including the sample application pad, conjugate pad, and other membranes.

In a second embodiment, the nitrocellulose membrane is part of a support platform and is separated from the other membranes by employing a mesh screen, comprised of a material such as nylon, as part of the pillbox container, so that the membrane can be viewed by sliding away the various other membranes.

The intensity of the reaction can be quantified by a conventional hand-held colorimeter. Thus, in one embodiment, the rapid detection test kit of the present invention provides a quantitative as well as qualitative in vitro diagnostic for the detection of antibodies to viruses and/or bacteria in human body fluids and thus is very effective in qualifying the success of vaccinations.

The present invention is directed toward multiple embodiments. Reference will now be made in detail to specific embodiments of the invention. Language used in this specification should not be interpreted as a general disavowal of any one specific embodiment or used to limit the claims beyond the meaning of the terms used therein. Any alterations and further modifications in the described embodiments, and any further applications of the principles of the invention as described herein are contemplated as would normally occur to one skilled in the art to which the invention relates.

The rapid detection kit of the present invention is advantageous, among several other attributes, in that it provides an inexpensive, quick, sensitive and safe method for detection of response to vaccination. In a first embodiment, the nitrocellulose membrane is fully contained within a pillbox container, having various layers, including the sample application pad, conjugate pad, and other membranes.

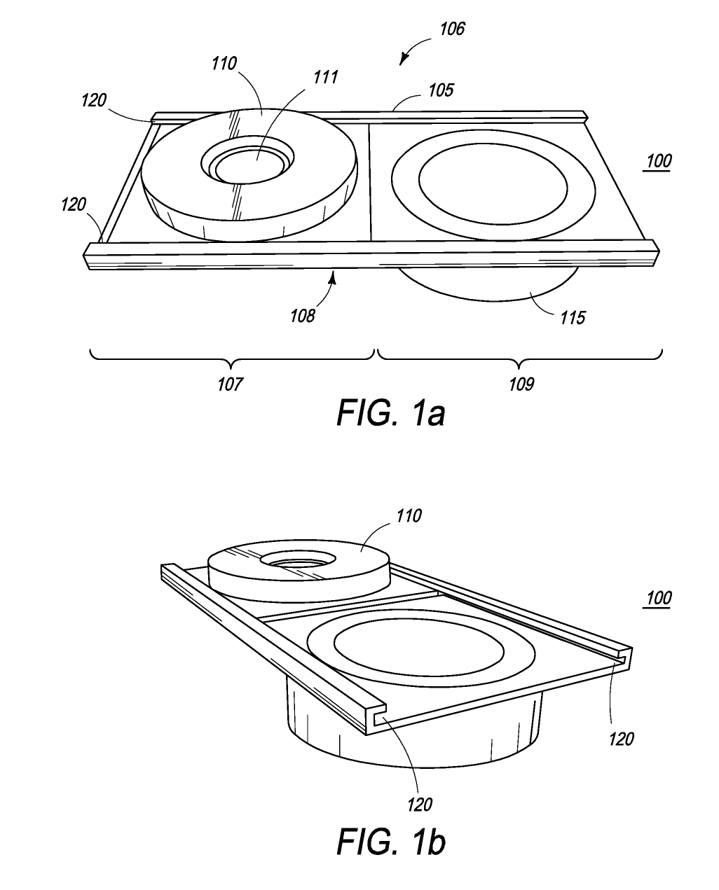

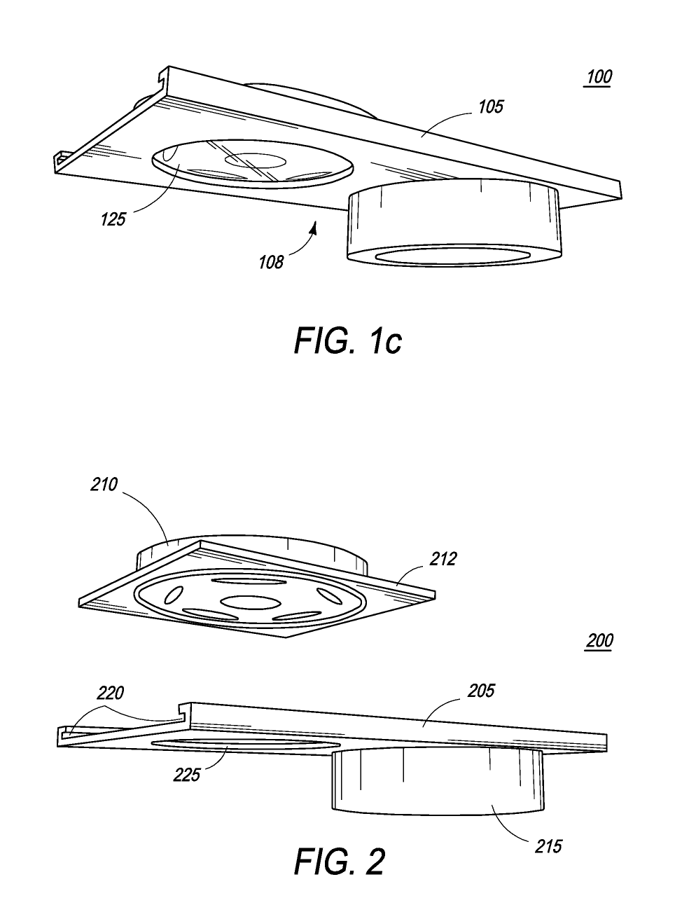

As shown in FIGS. 1a, 1b, and 1c, the rapid detection kit 100 of the present invention is fully self-contained, requires no refrigeration for storage or transport, and if a plasma or serum specimen is used in testing, only a standard lab refrigerator is needed. Additionally, the rapid detection test kit of the present invention can be stored at ambient temperature for a relatively long time without affecting detection sensitivity.

In one embodiment, all reagents necessary to perform the detection test are contained in the rapid detection test kit 100, providing a simple, ready-to-use, stable device that can be employed in field conditions. Now referring to FIG. 1a, the fully assembled rapid detection test kit 100 of the present invention further comprises support platform 105. In one embodiment, support platform 105 has a top side 106 and a bottom side 108 and comprises two portions—first portion 107 and second portion 109. In one embodiment, rapid detection test kit 100 of the present invention further comprises pillbox shaped container 110, which can be slid into grooves 120 located on the top side 106 of platform 105 and along the length of the first portion 107 and second portion 109.

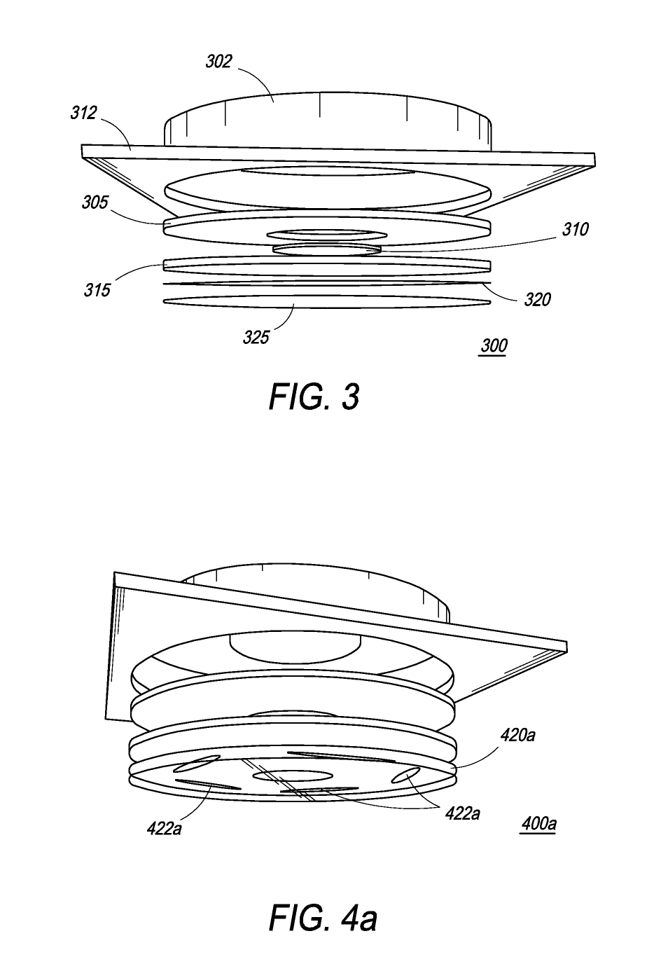

As shown in FIG. 1b, grooves 120 are formed such that they receive at least a portion of pillbox container 110. Referring back to FIG. 1a, pillbox container 110 further defines an opening 111 in the center of the pillbox for receiving a sample. Components of pillbox container 110 will be described in detail below with respect to FIG. 3. In one embodiment, rapid detection test kit 100 of the present invention further comprises absorbent sponge pad holder 115, which comprises a sponge pad (not shown). Preferably, absorbent sponge pad holder is affixed to bottom side 108 of support platform 105, and positioned within second portion 109. In one embodiment, the sponge pad is treated with a buffer.

Exemplary wash buffers that may be employed with the present invention include, but are not limited to those that are buffered to a pH ranging from 5-10, and further comprising a surfactant or detergent. Suitable buffers include 10 to 100 mM Tris, and preferably, Tris maleate. Suitable detergents include Tween 20 and Triton X 100. In some embodiments, the wash buffer may further comprise a water miscible polar organic solvent and an alkali metal or ammonium salt present in an amount to provide an ionic strength of at least approximately 0.25.

FIG. 1c is a partial underside view of rapid detection test kit 100. Referring now to FIG. 1c, structured platform 105 further defines a window 125 for viewing test results. Optionally, window 125 is covered with a transparent polymer film.

FIG. 2 is an illustration of a self-contained rapid detection kit of the present invention shown in FIGS. 1a, 1b, and 1c, with the pillbox assembly removed. As shown in FIG. 2, rapid detection test kit 200 of the present invention, in one embodiment, comprises support platform 205, for supporting pillbox container 210 and absorbent sponge pad holder 215. In one embodiment, support platform 205 is comprised of plastic, cardboard or other rigid material. Pillbox container 210 further comprises a collar portion 212. The support platform 205 further comprises grooves 220 for receiving collar portion 212 of pillbox container 210. Support platform 205 defines a void or space, which functions as a window 225, that is used for positioning test results above said window. Optionally, window 225 further comprises a transparent polymer film coating.

As discussed above, in one embodiment, the present invention employs at least one method of fluid movement technology for testing the human fluid sample for the presence of antibodies. Thus, in one embodiment, the layers contained within pillbox reagent container 210 supports the use of SINK-SORB technology. In another embodiment, the layers contained within pillbox reagent container 210 supports the use of lateral flow technology.

Absorbent sponge pad holder 215 comprises an absorbent material for washing away excess reagents. In one embodiment, the absorbent sponge pads are used to soak up large quantities of wash buffer solution and thus suitable materials include, but are not limited to highly absorbent materials such as soft polyurethane or cellulosic material, such as cotton or synthetic wool (rayon).

FIG. 3 is an expanded view of the various layers in one embodiment of a pillbox container assembly used in the rapid detection test kit of the present invention. As shown in FIG. 3, pillbox container 300 comprises a housing or plastic holder 302, which, in one embodiment, is a cylindrical container resembling a pillbox. Housing 302 is used to contain at least one layer, including impervious support sheet or membrane layer 305 for providing support to sample pad layer 310, preferably made of plastic, cardboard, or nitrocellulose or combinations thereof.

Still further, housing 302 houses gold conjugate pad 315 and reaction membrane 320. Optionally, polymer sheets 325 are used to cover certain portions of the device, including a void within the platform and the reaction membrane 320 to preserve the reaction membrane prior to use. In one embodiment, polymer sheet 325 is removed prior to use.

In one embodiment, polymer sheet 325 comprises a sheet comprised of a transparent polymer. Preferably, the polymer is a hydrophilic polymer, thus increasing the shelf like and preserving the stability of the diagnostic kit. Thus, in one embodiment, the hydrophilic polymer may comprise, but is not limited to, synthetic polymers, colloidon, disaccharides (such as trehalose), natural polymers (such as chitosan, glucosamine and N-acetyl glucosamine). In another embodiment, the polymer is a hydrophobic polymer such as PVP, PVC, or polythene.

In one embodiment, pillbox container housing 302 is further supported by a collar portion 312, that is used to slide pillbox container 300 into grooves (not shown) in the housing (not shown) of the rapid detection test kit of the present invention.

The sample pad layer 310 may comprise a sample pad formed from a material that increases the concentration of the sample, thus improving the sensitivity of the membrane-based immunoassay. The sample pad 310 is used for receiving a sample dispensed along with a diluent. A typical suitable diluent is a buffered solution that includes a detergent, a protein or carbohydrate, and a negatively charged organic compound. The sample pad material may be any material suitable for improving concentration and thus, test sensitivity, including any material having high capillary action, such as cotton or paper as described in U.S. Pat. Nos. 5,185,127; 5,006,464; 3,888,629; and 4,818,677, which are herein incorporated by reference.

In use, a sample is placed on the sample pad and flows through the sample pad onto the conjugate pad, where it forms a complex with the detector reagent, as described below. Preferably, the sample is an animal or human body fluid. Still preferably, the test sample is any material that may contain antibodies that bind to immobilized antigens, generally derived from an animal or human, including, but not limited to blood, saliva, tears, urine, plasma, mucous, ascites fluid, synovial fluid, vaginal fluid, amniotic fluid, sweat, or cerebrospinal fluid. In addition to the fluids listed, a solid material or its extract that may contain antibodies specific for the immobilized antigen can also be used as the test sample, such as but not limited to, feces. Preferably, a very small sample size is needed to perform the detection test. For example, if a human fluid sample is used, an average sample size is 2 drops.

In one embodiment, gold conjugate pad 315 comprises particles deposited thereon, such as colloidal gold (metal sol) or colored latex particles, which when placed into contact with the animal or human derived sample potentially containing at least one antibody, form a complex with the potential antibodies that may be present in the sample. Once the complex is formed, it moves across a series of membranes, and produces a colored line of antigen-antibody complex to indicate the presence of specific antibodies for a particular antigen. The mechanism of the test kit reaction is described in greater detail below.

In one embodiment, the metal sol (nano-gold) or colored latex particles attached to the antibody are preferably in the range of about 20 to 120 nm and still more preferably, in the range of 20 to 40 nm.

In accordance with the present invention, the metal sol particles being used can be prepared using methods well-known to those of ordinary skill in the art. For example, one exemplary method for preparing gold sol particles is described by G. Frens in Nature, 241, 20-22 (1973), which is herein incorporated by reference. Other methods include, but are not limited to hydrophobic bonding and covalent coupling. The metal sol particles may be metal or metal compounds or polymer nuclei coated with metals or their compounds such as platinum, gold, silver, selenium, or copper exhibiting characteristic colors and are described in U.S. Pat. No. 4,313,734, which is also herein incorporated by reference.

A complex may also be prepared by coupling a sample to the colored nanogold particles using biotin/streptavidin linkage where the sample fluid is biotinylated and the metal sol particle is coated with the streptavidin. The streptavidin on the particle then reacts with biotin on the sample for coupling together both the substance and the particle. Thus, in one embodiment, the conjugate comprises biotinylated anti-human IgG or IgA antibodies complexed with streptavidin conjugated gold or colored latex nano-particles.

In another embodiment, analytes can also attach to dyed or fluorescent labeled microparticles such as latex, silica, dextran, polystyrene, polycarbonate and carbon. The metal sol particles and fluorescent labeled microparticles, however, should be visible enough to be read with an instrument such as a fluorescent reader, spectrophotometer and the like.

In an alternate embodiment, Staphylococcal Protein A or Streptocccal Protein G are conjugated to the gold or colored latex nanoparticles to capture and visualize the presence of a specific immune response.

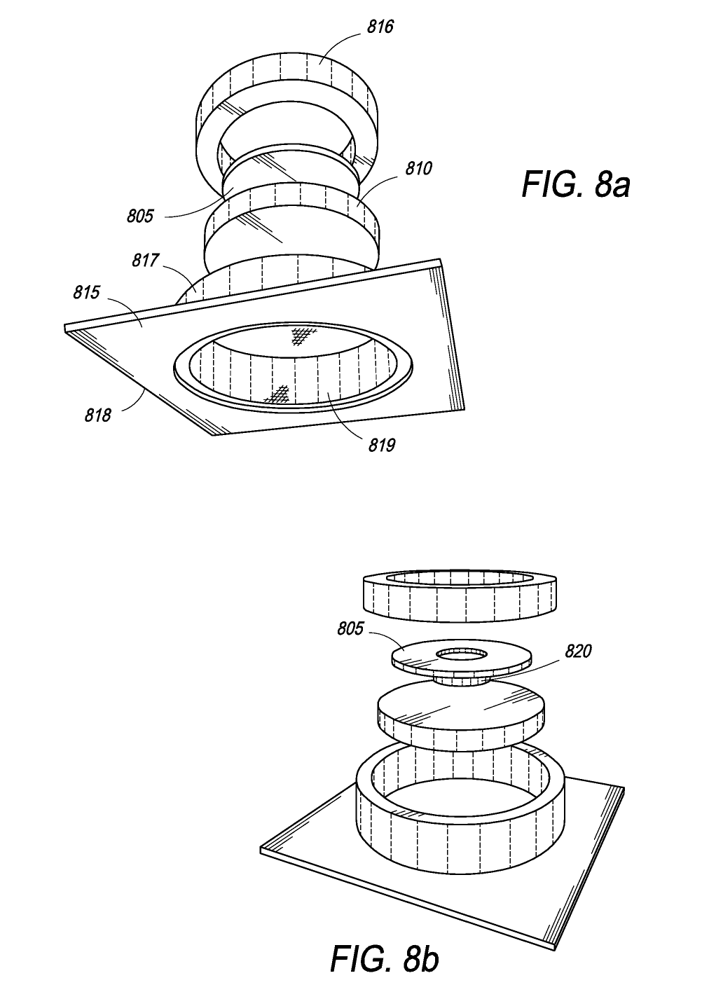

In one embodiment, reaction membrane 320 comprises a membrane that incorporates capture antigens, thus forming at least one reaction zone. More specifically, in one embodiment, the reaction membrane strip 320 comprises at least one capture antigen, extracted from at least one vaccine, immobilized or deposited thereon. In one embodiment, the capture antigen may be further processed for test efficacy and stability, as described in further detail below. While the nitrocellulose membrane is described as integral to the pillbox container in this embodiment, it should be noted that in another embodiment, described in detail below with respect to FIGS. 7, 8a, and 8b, the nitrocellulose membrane is part of a support platform and is separated from the other membranes by employing a mesh screen, comprised of a material such as nylon, as part of the pillbox container, so that the membrane can be viewed by sliding away the various other membranes.

In one embodiment, the reaction zone material is comprised of a porous membrane having a size ranging from 0.05 to 20 microns, and preferably 10 microns, thus permitting separation and filtration of non-essential components from the test sample. Exemplary membranes are well-known to those of ordinary skill in the art. The membrane chosen should not, however, adversely affect detection performance and should be compatible for analyzte (antigen) immobilization. The membrane may be composed solely of nitrocellulose or from a combination of any of nitrocellulose, glass fiber, polyester, cellulose nitrate, polycarbon, nylon and other synthetic or natural materials as described in U.S. Pat. Nos. 4,670,381; 4,632,901; 4,517,288; 4,666,863; and 4,552,839, which are herein incorporated by reference.

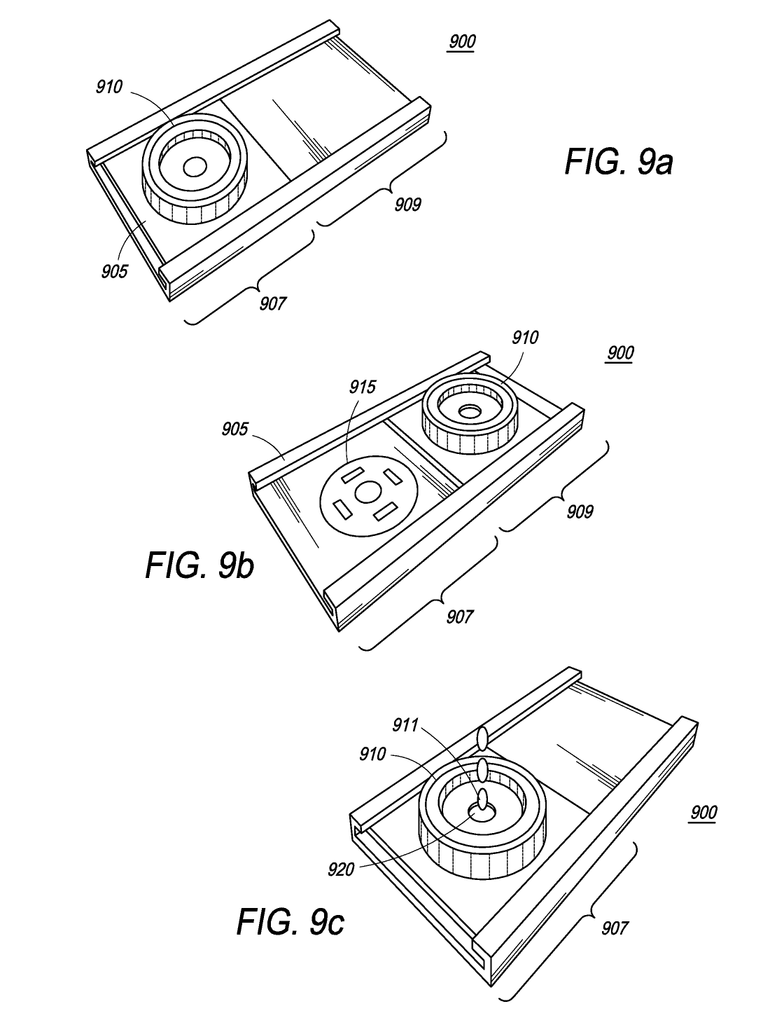

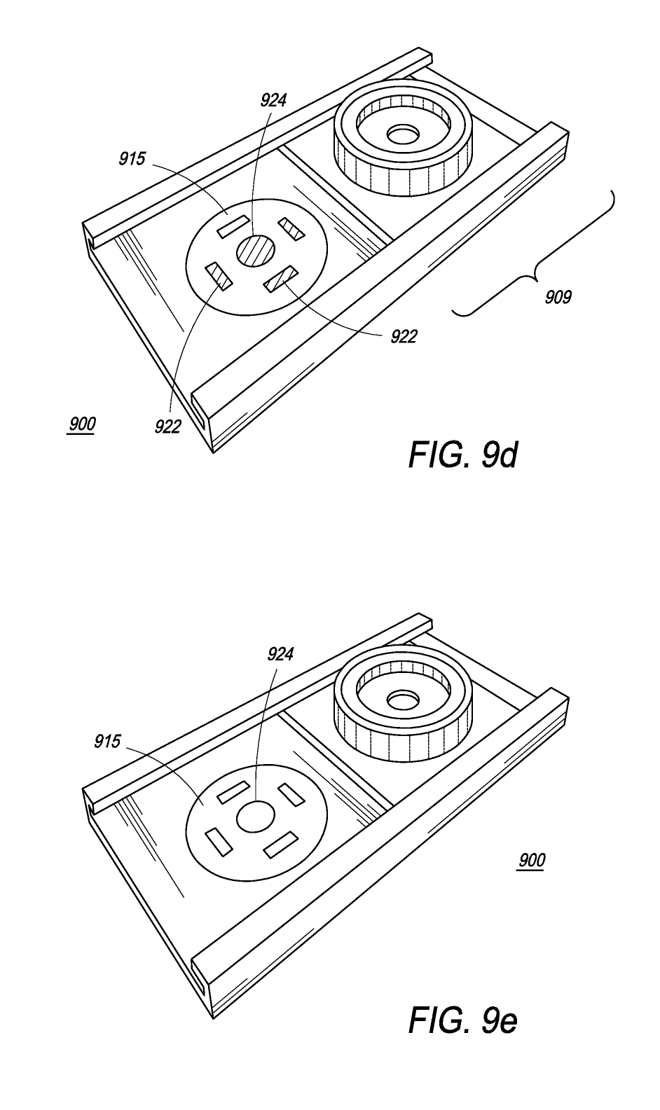

Typically, the at least one antigen analyte (viral/bacterial lysate) immobilized on the membrane is one that specifically binds to any anti-viral/bacterial antibody that may be present in the sample to be screened. Thus, the rapid detection kit of the present invention can be designed to detect the presence of any antibody, and further, multiple antibodies. In one embodiment, a specific antigen is produced and immobilized on the membrane for detection of polio vaccine antibody. The specific polio antigen and its use in the rapid detection test kit of the present invention is described in further detail below with respect FIGS. 9a, 9b, 9c, 9d, and 9e, showing a detailed example of use of the device of the present invention.

Analytes can be immobilized onto materials such as nitrocellulose by methods such as adsorption, absorption, or covalent bonding. As is well-known in the art, immobilization by covalent bonding involves a coupling agent, such as a cyanogen halide (cyanogen bromide) or gluteraldehyde, as described in U.S. Pat. No. 4,186,146, which is herein incorporated by reference. Suitable procedures for immunological immobilization are described by Iman and Hornby in Biochemical Journal (Vol. 129; page 255), which is also herein incorporated by reference. In addition, chemically pretreated materials suitable for coupling of analytes are commercially available.

In an optional embodiment, the membrane is treated with a blocking solution to prevent the non-specific binding of the target substance and other sample components to the reaction zone. Common blocking solutions, such as those comprising BSA (1 to 10%) or other proteins which do not cross-react with reagent materials contained in the detection system, may be employed. The detection system is ready for use as soon as the blocking solution is dried. In some cases, the blocking step is negated if, for example, a good quality paper-backed nitrocellulose membrane is being used.

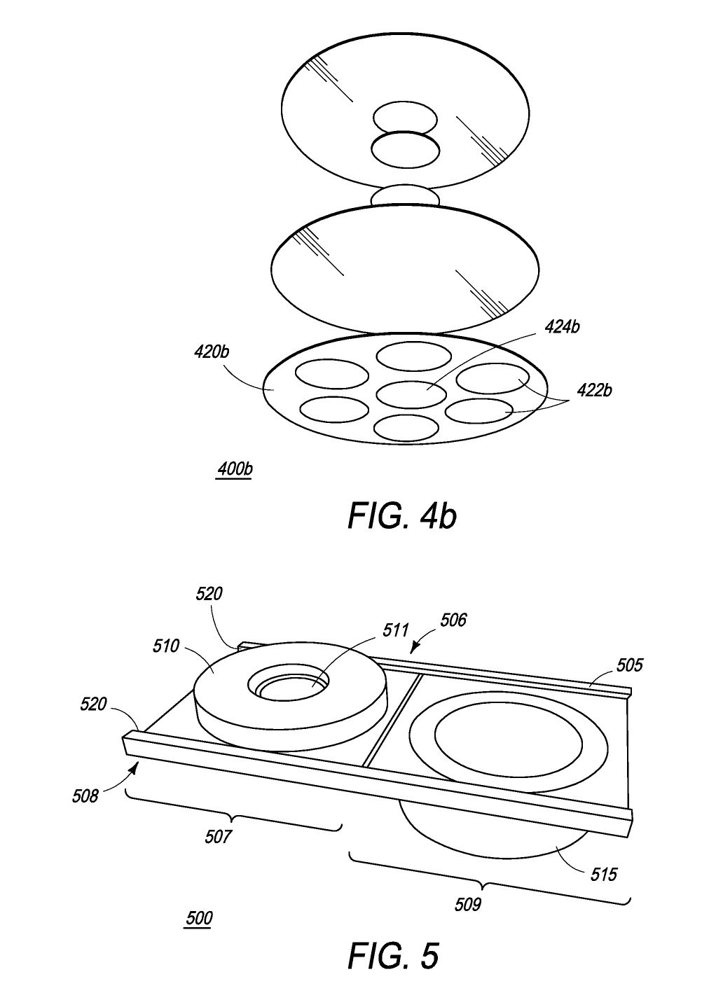

As shown in FIGS. 4a and 4b, a plurality of protective antibodies can be detected for corresponding vaccines in a radial design of the detection device using SINK-SORB technology. FIG. 4a shows a pillbox container 400a having a membrane 420a upon which a plurality of antigens (and thus, reaction zones) 422a are radially immobilized.

FIG. 4b is an expanded view of membrane 420b having a plurality of antigens 422a radially positioned. Membrane 420b further comprises a central control antigen 424b. The radial placement of antigens advantageously allows for simultaneous analysis of multiple antigen or vaccine-derived immune responses without compromising the test kit performance due to diffusional limitations that may be presented with the use of conventional lateral flow technologies. More specifically, since conventional lateral flow technologies are linear, a maximum of one or two antigens can be placed in a diagnostic kit.

FIG. 5 is a top-down illustration of the rapid detection test kit of the present invention, employing a pillbox container designed for use with SINK-SORB technology. As shown in FIG. 5, the fully assembled rapid detection test kit 500 of the present invention comprises a support platform 505. In one embodiment, support platform 505 has a top side 506 and a bottom side 508. In one embodiment, support platform 505 comprises two portions—first portion 507 and second portion 509. In one embodiment, rapid detection test kit 500 of the present invention further comprises pillbox container 510. Pillbox container 510 further comprises a collar portion (not shown), which can be slid into grooves 520 on the top side 506 of platform 505. Grooves 520 run along the length of both first portion 507 and second portion 509, so that pillbox container 510 can be slid across the length. Components of pillbox container 510 have been described above and will not be repeated herein.

In one embodiment, rapid detection test kit 500 of the present invention further comprises absorbent sponge pad holder 515, which comprises a sponge pad (not shown). The sponge pad is preferably treated with a buffer. Suitable buffer solutions have been described in detail above and will not be repeated herein. Absorbent sponge pad holder is affixed to bottom side 508 of support platform 505, and positioned in second portion 509.

To perform a test using the rapid detection test kit 500 of the present invention, the device is first unpacked. The kit contains, in a packaging, the support structure, container, sponge pad, a buffer, and, optionally, an application pad. The clinician ensures that the pillbox container is on the top side 506 of support platform 505, and positioned in first portion 507 via the grooves. A sample is then applied to a sample pad (not shown) via an opening 511 defined by pillbox container 510. In another embodiment, an application pad containing a sample is placed through the opening 511 in pillbox container into an opening in the support membrane (not shown).

The clinician removes a transparent film that covers the base nitrocellulose membrane layer and applies a buffer to allow the antibodies that may be contained within the sample to move downward (gravity-based flow in addition to capillary suction). Thus the combination of gravity and capillary action pulls the fluid through a conjugate pad so that the sample can complex with gold conjugate. The fluid is then pulled through to the antigen support membrane so that the complexed sample reacts with antigen spots (not shown) on the membrane.

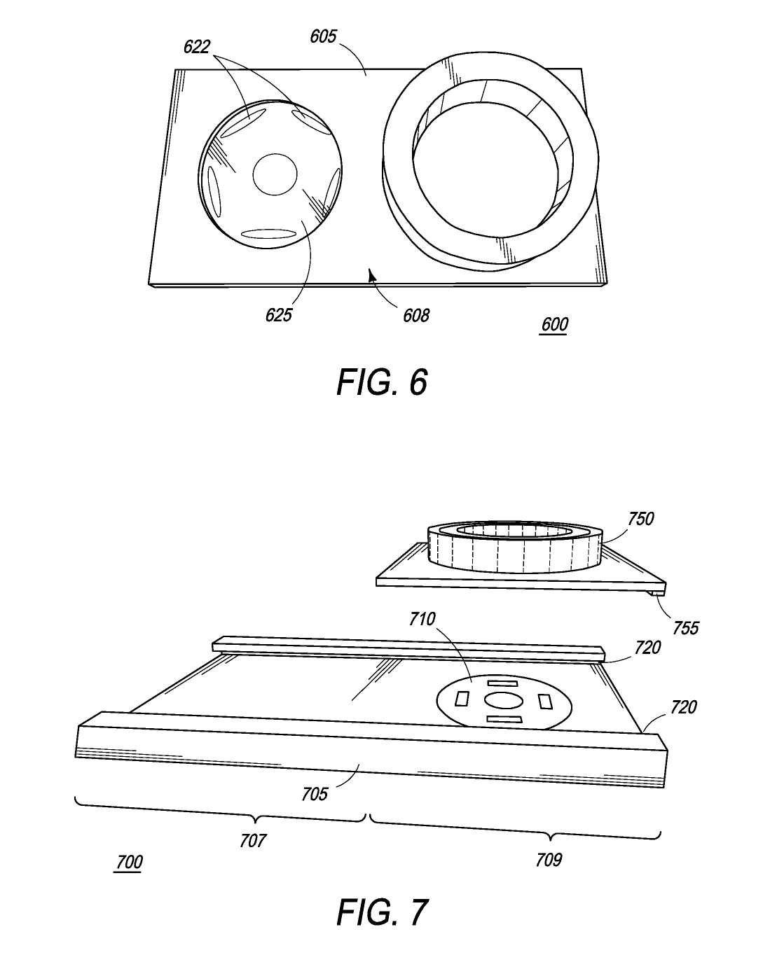

The clinician then slides pillbox container 510 from first portion 507 to second portion 509 so that it can come into contact with a buffer contained on an absorbent sponge pad located in absorbent sponge pad area 515. The clinician then presses the sponge pads so that the buffer squirts and washes any excess gold conjugate from the membrane. Pillbox container 510 is then slid back to first portion 507, where the rapid detection kit 500 is then overturned to show test results, as shown in FIG. 6.

FIG. 6 is an illustration of a rapid detection test kit 600 of the present invention, further showing test results in antigen spots 622 on the bottom side 608 of a support platform 605, seen through transparent film window 625.

In a second embodiment, the nitrocellulose membrane is part of a support platform and is separated from the other membranes by employing a mesh screen, comprised of a material such as nylon, as part of the pillbox container, so that the membrane can be viewed by sliding away the various other membranes. It should be noted that the pillbox container is substantially the same as that described above with respect to a first embodiment, except that the nitrocellulose membrane is, in this embodiment, not integral to the pillbox container and affixed to the support platform. An additional difference is that the pillbox assembly further comprises a wipe sponge.

FIG. 7 is a side perspective view of a second embodiment of a self-contained rapid detection kit of the present invention, in which the test membrane is part of a support platform and with the pillbox assembly removed from the support platform. Now referring to FIG. 7, rapid test detection kit 700 of the present invention further comprises a support platform 705, a membrane 710 removably connected to support platform 705, and grooves 720 for receiving a pillbox container assembly 750. Support platform 705 further comprises a first portion 707 and a second portion 709. In one embodiment, support platform 705 is fabricated from plastic or other suitably rigid material. Pillbox container assembly 750 is described in further detail below with respect to FIGS. 8a and 8b. In one embodiment, pillbox assembly 750 further comprises a wipe pad 755. In one embodiment, wipe pad 755 is a sponge or any other absorbent material. It should be noted herein that membrane 710 has already been described in great detail above and that such detail will not be repeated herein. In one embodiment, membrane 710 is a nitrocellulose membrane.

FIGS. 8a and 8b are expanded views of the various layers in one embodiment of a pillbox container assembly used in the rapid detection kit of the present invention as shown in FIG. 7. Referring now to FIG. 8a, pillbox assembly 800 comprises an impervious sheet 805, gold conjugate pad 810, plastic holder 815 and retaining plastic ring 816. In one embodiment, plastic holder 815 further comprises plastic ring portion 817, collar 818, and nylon mesh 819. Collar 818 is used to slide pillbox assembly 800 into grooves (not shown) formed from a support platform, described and shown with respect to FIG. 7. Nylon mesh 819 is used to separate the pillbox assembly membranes from the nitrocellulose membrane (not shown) contained within the support platform.

Referring now to FIG. 8b, pillbox assembly further comprises sample application pad 820. Sample application pad 820 can be positioned within impervious sheet 805.

The components of pillbox assembly 800 have been described above with respect to a first embodiment, shown in FIGS. 1-6. Thus, the characteristics of the components will not be described herein.

In an exemplary embodiment, the present invention is directed towards a rapid detection test kit for detecting an antibody response (or lack thereof) after vaccination with a polio vaccine. By way of background, polio is a crippling disease caused by one of three types of polio viruses—namely Types 1, 2, and 3. Two types of vaccines are available for worldwide disease control—attenuated (Sabin's oral polio vaccine) and killed (Salk's inactivated polio vaccine). The oral vaccine containing all three virus types is currently being administered, in either multiple dose or pulse campaigns. There is, however, no inexpensive and rapid diagnostic test, that can be used in the field for evaluating the efficacy of the immunization.

One particular problem is in the production of large quantities of pure, intact virion antigens of polio due to the stability issues discussed above. Thus, conventional methods applied to other viruses for use in diagnostic tests cannot be broadly applied in the case of polio antigens.

FIGS. 9a, 9b, 9c, 9d, and 9e are various illustrations of an exemplary rapid detection test kit for testing the efficacy of an administered polio vaccine, while in use. As shown in FIG. 9a, when fully assembled, the rapid detection kit 900 of the present invention comprises a pillbox assembly 910 fitted onto platform 905. In one embodiment, platform 905 further comprises first portion 907 and second portion 909.

Prior to initiating a test, as shown in FIG. 9b, pillbox assembly 910 is slid from first portion 907 to second portion 909 of platform 905, to expose membrane 915, which is integral to platform 905, to ensure that membrane 915 has no colored spots. If the membrane has no colored spots, it is a clean and usable test membrane. The pillbox assembly is then slid back from second portion 909 to first portion 907 so that it rests directly over membrane 915, as shown in FIG. 9c.

Referring now to FIG. 9c, to begin testing, a biological sample is then dispensed, along with diluents, onto the sample pad 920 in sample drop area 911. The sample is allowed to “SINK-SORB”, whereby approximately 2 drops of buffer is subsequently placed on the sample pad to allow the antibodies in the sample to move down towards the conjugate pad. Suitable buffers have been described in detail above and will not be repeated herein.

From the sample pad, the biological sample flows onto the conjugate pad (not shown), where it forms a conjugate with detector reagent. The mixture then moves across the test membrane, contained on the support platform, where it binds with test and control reagents.

Of particular importance for use in a diagnostic test are polio viral antigens VP1 and to a lesser extent, VP2. The antigenicity of the viral antigen, however, is completely lost if the virion is disrupted and no longer intact. It should be noted that polio viruses, in particular, are highly thermolabile and require stabilization via the use of stabilizer molecules, such as molar magnesium chloride, a polar disaccharide, or a protein stabilizer under ideal pH and temperature conditions. Thus, it is important to preserve intact virion architecture for use in diagnostic test kits.

Thus, the antigens used in the polio vaccine rapid diagnostic test kit of the present invention are prepared such that the virions remain intact, lending stability to the test kit as a whole. In one embodiment, the virus (antigen) is inactivated by treatment with 0.2% to 0.4% formalin. Viral inactivation results in irreversible methylol and dimethylol bridges between amino acids of the viral peptides both within the virions and between the virions. It should be noted that the formalin inactivation treatment can only be performed if the virus is highly purified. In order to purify the virus, the virus is concentrated. In one embodiment, the virus is concentrated using ultrafiltration via polysulfone or other appropriate media with nominal molecular exclusion limits of 300,000 to 1,000,000. In another embodiment, the virus is concentrated via precipitation, using salting in and salting out methods, such as but not limited to zinc sulfate, zinc acetate, zinc chloride, ammonium sulfate, and ammonium acetate. The salt is removed by dialysis against an appropriate standardized buffered solution or water. The resultant concentrated virus is purified by gel filtration and/or ion exchange chromatography using anionic exchangers or affinity chromatography using ligands such as CD-155 peptide (polio virus receptor) or other appropriate antibody.

In another embodiment, the viral is inactivated by treatment with betapropiolactone (BPL), having a concentration in the range of 1:2000 to 1:60,000 and preferably a concentration of 1:4000. Treatment is effectuated using different methods of addition, such as adding total calculated volume of the inactivating chemical into at least two installments at temperatures ranging from 0° to 37° C. at exposure times ranging from a few minutes to several days.

In one embodiment, as indicated by normal ELISA tests, the amount of antigen (and thus virus) used to coat the membrane is on the order of at least 10⁹ to 10¹⁰ TCID50 doses. In one embodiment, after the antigens are applied on the test membrane, which in this case is a nitrocellulose membrane, the membrane is covered with a thin layer of polymer. Preferably, the polymer is a hydrophilic polymer, thus increasing the shelf like and preserving the stability of the diagnostic kit. Thus, in one embodiment, the hydrophilic polymer may comprise, but is not limited to, synthetic polymers, colloidon, disaccharides (such as trehalose), natural polymers (such as chitosan, glucosamine and N-acetyl glucosamine). In another embodiment, the polymer is a hydrophobic polymer such as PVP, PVC, or polythene.

In an alternate embodiment, the integrity of the virion may be preserved by inactivating the virus after application onto the nitrocellulose membrane, thereby creating a cross-linkage onto the membrane.

Now referring to FIG. 9d, in order to read the test results of test 900, the pillbox container 910 is slid onto second portion 909, to first wipe away any excess reagent from the membrane using the mop pad (not shown), described with respect to FIG. 7 and subsequently, reveal the membrane 915. If the mixture binds to the reagent and forms a visual indication on an antigen reaction area 922, then a positive result is indicated, wherein a positive result is indicative of the presence of antibody. The test is a valid test if the control spot 924 is positive, indicated by the presence of color.

As shown in FIG. 9e, if the control spot 924 on membrane 915 is not colored in, then the test 900 is invalid. In one embodiment, the test results are viewed from the underside of the rapid detection test kit of the present invention, through a transparent polymer window, as described above.

The present invention, as presented above, thus overcomes the limitations of using conventional lateral flow technology by employing an improved lateral flow method in which a single central sample application pad is used to deliver a test sample to several lateral flow membranes that are arranged radially. Thus, the rapid detection kit of the present invention provides an improved lateral flow detection system for convenience, speed, and utility in which viral/bacterial or other pathogenic lysate or their derivatives are radially immobilized on a membrane strip to perform the reaction.

To prevent any interference in visualization of a color reaction in the detection, in an alternate embodiment, the rapid detection test kit of the present invention includes a portion for receiving and separating the fluid portion of a whole blood sample from the RBSs featuring a blood separation zone. Various methods are described for separation of red blood cells from blood fluid using separation coatings, erythrocyte aggregating and agglutinating agents and polymer containing matrixes in U.S. Pat. Nos. 3,768,978, 3,902,964, 4,477,575 and 4,594,372, which are herein incorporated by reference.

In another embodiment, the support platform can accommodate multiple membranes, which comprise multiple antigen test spots.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

We claim:

1. An apparatus for rapidly measuring post-vaccination immune status, comprising:
a. a support platform, having a top side, a bottom side, a first portion, a second portion, wherein a first void is integrally formed in said first portion;
b. a container configured to be removably affixed to the top side of the support platform, wherein said container comprises a housing, a base, and at least one reactant and wherein the base of said container can be viewed through said first void when said container is removably affixed to the first portion of the top side; and
c. an absorbent material affixed to said second portion, wherein the base of said container comes into contact with said absorbent material when said container is removably affixed to the second portion of the top side.

2. The apparatus of claim 1 wherein the support platform comprises a plurality of grooves.

3. The apparatus of claim 2 wherein the container comprises a collar configured to be slidably inserted into, and out of, said grooves.

4. The apparatus of claim 1 wherein the container comprises a sample pad layer, at least one layer for providing support to the sample pad layer, a conjugate pad, and a reaction membrane.

5. The apparatus of claim 1 wherein the container further comprises a polymer membrane.

6. The apparatus of claim 1 wherein the absorbent material comprises a buffer.

7. The apparatus of claim 1 wherein the first void is covered with a transparent polymer film.

8. The apparatus of claim 4 wherein said sample pad layer is formed from a material that increases a concentration of a sample applied to said sample pad layer.

9. The apparatus of claim 4 wherein said conjugate pad comprises gold particles, which when placed into contact with a sample containing at least one antibody, form a complex with said antibody.

10. The apparatus of claim 4 wherein said reaction membrane comprises a porous membrane having at least one capture antigen.

11. The apparatus of claim 10 wherein said porous membrane is of a size ranging from 0.05 to 20 microns.

12. The apparatus of claim 10 wherein said reaction membrane comprises a plurality of capture antigens radially positioned on the reaction membrane to allow for simultaneous analysis of multiple vaccine-derived immune responses.

13. The apparatus of claim 4 wherein a specific antigen is immobilized on the reaction membrane for detection of polio vaccine antibody.

14. The apparatus of claim 5 wherein the polymer membrane comprises at least one of a hydrophilic polymer, a synthetic polymer, colloidon, disaccharide, natural polymer, hydrophobic polymer, PVP, PVC, or polythene.

15. An apparatus for rapidly measuring post-vaccination immune status, comprising:
a. a support platform, having a top side, a bottom side, a first portion, a second portion, wherein a first void is integrally formed in said first portion and covered by a membrane;
b. a container configured to be removably affixed to the top side of the support platform, wherein said container comprises a housing, a base, and at least one reactant and wherein the base of said container is placed into contact with said membrane when said container is removably affixed to the first portion of the top side and wherein the base of said container is placed into contact with a material different from said support platform when said container is removably affixed to the second portion of the top side.

16. The apparatus of claim 15 wherein the container comprises a sample pad layer, at least one layer for providing support to the sample pad layer, and a conjugate pad.

17. The apparatus of claim 16 wherein the container further comprises a polymer membrane and a wipe pad.

18. The apparatus of claim 1 wherein the material different from said support platform is an absorbent material that comprises a composition for washing away excess regents.

19. The apparatus of claim 16 wherein said conjugate pad comprises gold particles, which when placed into contact with a sample containing at least one antibody, form a complex with said antibody.

20. The apparatus of claim 15 wherein said membrane comprises nitrocellulose.
